(19) United States
(12) Patent Application Publication
(10) Pub. No.: US 2026/0322865 A1
(43) Pub. Date: Oct. 15, 2026

(54) PREDICTIVE MANIFEST IN HTTP ADAPTIVE STREAMING

(71) Applicant: ORANGE, Issy-les-Moulineaux (FR)

(72) Inventors: Olivier GASTE, CHATILLON CEDEX (FR); Hervé MARCHAND, CHATILLON CEDEX (FR)

(21) Appl. No.: 19/683,957

(22) Filed: May 21, 2026

(30) Foreign Application Priority Data
May 23, 2025 (FR) 2505544

(51) Int. Cl. H04L 65/80; H04L 65/61

(52) U.S. Cl. CPC H04L 65/80; H04L 65/61

(57) ABSTRACT

A method for managing adaptive streaming of live digital content, implemented by a content server. The method includes generating a Manifest file containing a predictive section describing future segments of the digital content. This section includes unique identifiers for each future segment, timestamps indicating their availability, and, where appropriate, duration and repetition parameters to describe a plurality of future segments in a compact manner. The Manifest file is sent to a media streaming device, enabling the terminal to construct the URLs for the future segments and to synchronize their download with their actual availability. This approach reduces the update frequency of the manifest file, decreases bandwidth consumption, and optimizes server and client resources. The method can be applied to live HTTP adaptive streaming.

### CROSS-REFERENCE TO RELATED APPLICATIONS

This application claims priority to and the benefit of French Patent Application No. 2505544, filed May 23, 2025, the content of which is incorporated herein by reference in its entirety.

### TECHNICAL FIELD

This disclosure falls within the field of digital multimedia content, namely digital audio and/or digital video content. More specifically, the invention relates to the delivery of digital content accessible via a technique known as adaptive streaming, particularly live digital content.

### PRIOR ART

Access to multimedia content such as television or video-on-demand is currently available on most multimedia rendering terminals.

The terminal typically sends a request to a server, indicating the chosen content, and in return receives a stream of digital data corresponding to that content.

The terminal is configured to receive this digital content in the form of multimedia data and to render it. This rendering process consists of presenting the digital content on the terminal in a format accessible to the user. For example, received data corresponding to a video is typically decoded and then rendered on the terminal as a visual display of the video accompanied by its associated audio track. In the following, for simplicity, digital content will be treated as synonymous with video, and rendering by the terminal or consumption by the terminal user will be treated as synonymous with viewing the content on the screen of the terminal.

The distribution of digital content is often based on client-server protocols belonging to the HTTP (HyperText Transfer Protocol) family. In particular, the streaming of digital content enables data to be transported and consumed in real time, i.e. the digital data is sent over the network and rendered by the terminal as the data arrives. The terminal receives and stores a portion of the digital data in a buffer memory prior to rendering it. This distribution method is particularly useful when the data rate available to the user cannot guarantee real-time video transfer, for example due to fluctuations in available bandwidth.

HTTP adaptive streaming (abbreviated as HAS) also allows the distribution and reception of data at various levels of quality, for example corresponding to different data rates. These various levels of quality are described in a parameter file available for download from a data server, for example a content server. When a client terminal wishes to access content, this description file makes it possible to select the appropriate format for the content to be consumed, based on the available bandwidth or on the storage and decoding capabilities of the client terminal. This type of technique makes it possible, in particular, to take bandwidth fluctuations into consideration in the connection between the client terminal and the content server.

Several technical solutions exist to facilitate the streaming distribution of such content, for example proprietary solutions such as Microsoft® Smooth Streaming, Apple® HLS, and Adobe® HTTP Dynamic Streaming, or the MPEG-DASH standard developed by the ISO/IEC organization, which will be described below. These methods involve sending the client one or more intermediate description files, also called documents or manifests, which contain the addresses of the various segments of the multimedia content, each available in different levels of quality.

Thus, the standard known as MPEG-DASH (abbreviation for “Dynamic Adaptive Streaming over HTTP”) is a standard format for audiovisual streaming over the Internet. It is based on preparing the content as various presentations of varying quality and bit rates, separated into segments of short duration (typically a few seconds long), also known as “chunks.” Each of these segments is made individually available via an exchange protocol. The primary target protocol is HTTP, although other protocols (such as FTP) may also be used. The organization of the segments and their associated parameters are published in a manifest file in XML format.

Conventionally, new audio/video segments are produced by the content server and then incorporated into the manifest file upon completion of this production step. It therefore remains necessary to first produce the segments, make them accessible via Content Delivery Networks (CDNs), and then describe them in the manifest file so that clients can retrieve them.

The consumption of digital content via HTTP adaptive streaming (HAS) is becoming increasingly widespread. It is utilized by numerous streaming services, as well as by certain TV decoders, or set-top boxes, which use it to access non-linear content, such as Video on Demand (VOD), replay of television programs that were broadcast earlier, or offerings such as Network Personal Video Recorder (Network PVR, a digital content recording service performed by the content provider itself rather than at the residence of the end user).

Furthermore, other devices such as real-time multimedia streaming players also access digital content using an adaptive streaming mode for real-time (or live) television content. This is the case, for example, with the Chromecast® device developed by Google®, or CléTV® from Orange®. Such devices, more generically referred to as HDMI sticks, can also be used to access video-on-demand content.

Content providers may choose to construct segments of fixed duration, for example 2 seconds, or segments of fixed size and thus of variable duration, depending on whether the segment corresponds to static or relatively dynamic content.

In the context of live content, where all segments are of the same duration (for example 2 seconds), the client terminal conventionally retrieves the description file, or Manifest, every two seconds, so that it can remain as close as possible to the live broadcast and always have access to the latest segment produced by the content server.

However, it is becoming increasingly common to offer the client the ability to watch such live content after the fact, for example allowing them to rewind within live content (features such as “Live Control” or “Start Over”). It is therefore necessary for the description file to describe not just the most recent seconds of the live content (for example the last 60 seconds), but a much larger span of the content (for example all segments covering the last four or eight hours of the content).

Such a manifest file, which for example may represent four hours of content, represents a significant volume of data, reaching up to 400 KB for example. When offering the customer the ability to defer playback of live content, the description file is therefore much larger, but it still must be retrieved every two seconds to enable the customer to switch back to the live stream at any moment.

This therefore increases the time required for the client terminal to retrieve this description file, as well as the bandwidth consumed and the resources of the client terminal's processor (CPU) that are mobilized for parsing the retrieved XML (extended Markup Language) description file.

To solve these problems and reduce the bandwidth consumption due to the frequent downloading of a large manifest file, an initiative is currently under discussion and standardization within the MPEG-DASH group; according to this initiative, the client terminal would not retrieve the entire manifest file, but only those parts of the file that it has not yet downloaded.

However, there remains a need for an alternative technique for managing adaptive streaming (HAS) that addresses these disadvantages of the prior art.

### SUMMARY

This disclosure serves to improve this situation.

A method is proposed for managing the adaptive streaming (HAS) of live digital content from a content server to a multimedia streaming device, comprising a generation of a description file for the digital content, the file comprising a list of temporal segments of the content, wherein the generation comprises constructing a predictive section in the description file, this section describing, for at least one future segment of the digital content, a reserved identifier for that future segment and a temporal indication of a point in time from which the future segment will be available for download.

The generation of a description file (or manifest) containing a predictive section makes it possible to anticipate the availability of future segments of live digital content. Such anticipation allows reducing how often this file is generated by the content server, as well as how often the manifest file is downloaded by the client terminal. Such a prediction, in the description file, of the audio/video segments that will be produced for the content serves to reduce:
a. Bandwidth consumption: the terminal no longer needs to download the complete manifest file each time new segments are produced, but can rely on the predictive information to schedule the downloads of future segments;
b. Processing load on the client terminal: reducing the manifest download frequency decreases the CPU resources required to parse the manifest file, particularly when the file is large;
c. Server resource optimization: the server no longer needs to regenerate the manifest file each time a segment is produced, but only after a certain number of segments have been produced, which reduces the processing load on the server side.

The overall performance of the HTTP adaptive streaming (HAS) system is thus optimized, both at the server level and at the client terminal level, while maintaining an efficient synchronization with the segments produced in real time.

According to another aspect, a server is proposed for managing the adaptive streaming (HAS) of live digital content, comprising means for implementing such a method for managing adaptive streaming.

According to another aspect, a computer program is proposed comprising instructions for implementing a method for managing adaptive streaming (HAS) of live digital content as defined herein, when that program is executed by a processor of such a server. According to another aspect, a non-transitory, computer-readable storage medium is proposed on which such a program is stored.

According to another aspect, a method is proposed for the adaptive streaming (HAS) of live digital content from a content server by a multimedia streaming device, the method comprising a downloading of description file of the digital content, comprising a list of temporal segments of the content, wherein the downloaded description file comprises a predictive section describing, for at least one future segment of the digital content, a reserved identifier for the future segment and a temporal indication of the moment from which the future segment will be available for download.

Thus, for the multimedia streaming device, the manifest file download frequency is reduced compared to the prior art. For example, in the case of a description file for segments having a duration of 2 seconds, which in the prior art would require the client terminal to retrieve the manifest file every 2 seconds, it is possible to reduce the manifest file download frequency by a factor of thirty, provided that the file contains a predictive section for the segments corresponding to the next sixty seconds of the live content.

According to another aspect, a multimedia streaming device is proposed comprising means for implementing such a method for adaptive streaming.

According to another aspect, a computer program is proposed comprising instructions for implementing all or part of a method for adaptive streaming as defined herein, when the program is executed by a processor of such a multimedia streaming device. According to another aspect, a non-transitory, computer-readable storage medium is proposed on which such a program is stored.

Such storage media may be any entity or device capable of storing the program. For example, the medium may comprise a storage means such as ROM, for example a CD-ROM or a microelectronic circuit ROM, or a magnetic storage means, for example a USB flash drive or a hard drive.

Furthermore, such storage media may be a transmissible medium, such as an electrical or optical signal, which may be routed via an electrical or optical cable, by radio, or by other means, such that the computer program contained therein is remotely executable. The program according to the invention may, in particular, be downloaded over a network—for example, the Internet.

Alternatively, the storage medium may be an integrated circuit in which the program is embedded, the circuit being adapted to execute or to be used in the execution of the aforementioned method.

The features set forth in the following paragraphs may optionally be implemented, independently of one another or in combination with one another.

The predictive section describes, for the future segment(s):
a. a start time of the future segment(s);
b. a duration of the future segment(s).

By describing a start time and a duration for at least one future segment, in the predictive section of the manifest file, the method allows the client terminal to precisely schedule the downloading of future segments. By means of the indicated start time and duration, the terminal can accurately determine the exact moment at which each future segment will become available for download. Furthermore, these parameters allow the client terminal to construct the download address for these future segments even before they have been produced by the content server.

The temporal segments of the content are of equal duration, and the predictive section also describes, for the future segment(s), a number of repetitions of the segment(s).

By describing, in the predictive section of the manifest file, a number of repetitions for at least one future segment in cases where the temporal segments are of equal duration, such a method allows reducing the size of the manifest file. By utilizing a repetition parameter (r, for example), it becomes possible to describe several consecutive segments of equal duration using a single line in the manifest, rather than describing each segment individually. This therefore reduces the volume of data to be transmitted.

Furthermore, the client terminal can rapidly interpret the information in the predictive section due to its compact structure, thereby reducing the processing load (parsing) required to analyze the manifest file.

The generation of the description file is repeated only after the content server has produced the future segment(s) described in the predictive section.

The server no longer needs to regenerate the manifest file when each segment is produced, only after a certain number of predicted future segments have been produced. This reduces the processing load on the server. By spacing apart the regenerations of the manifest file, the server can allocate its resources to other tasks, thereby enhancing its overall efficiency.

Such a method for adaptive streaming further comprises:
a. Constructing download addresses, based on the predictive section, for a plurality of future segments of the digital content;
b. downloading one of the future segments among the plurality, at the download address constructed for that future segment, starting at the moment associated with the temporal indication for the future segment.

Thus, for the multimedia streaming device, the sequence of constructing download URLs and downloading the segments is modified relative to the prior art. In the prior art, the client terminal constructed the download URL for a segment on the basis of the manifest file, and then downloaded the segment from that URL. In the technique of the invention, however, the client terminal can construct the URLs for a plurality of future segments, and then can wait to download each of these segments until the current time corresponds to the segment's availability timestamp indicated in the predictive manifest.

According to another aspect, the download of the description file is repeated only upon completing the download of the plurality of future segments described in the predictive section.

The content server, the multimedia streaming device, and the corresponding computer programs mentioned above offer at least the same advantages as those imparted by the method for managing adaptive streaming or by the method for adaptive streaming according to the present invention.

### BRIEF DESCRIPTION OF DRAWINGS

Other features, details, and advantages will become apparent upon reading the detailed description below and analyzing the annexed drawings, in which:

FIG. 1 shows an example of a streaming architecture based on the use of adaptive streaming, according to one embodiment of the invention.

FIG. 2 Illustrates an architecture of a multimedia streaming device of FIG. 1, according to one embodiment.

FIG. 3 depicts a block diagram describing a method for managing adaptive streaming for live digital content with a predictive manifest, according to one embodiment.

### DESCRIPTION OF EMBODIMENTS

Within the context of adaptive streaming of live digital content, the general principle of the invention is based on generating a predictive section in the manifest file, which serves to describe future segments of the content.

A “future segment” refers to an audio or video segment of live digital content that has not yet been produced by the content server, but which is scheduled to be produced at a later time.

In one embodiment, this segment is described in advance in a predictive section of the manifest file, with information such as:
1. A reserved identifier, enabling the unique identification of the future segment.
2. An availability time, indicating the precise moment (timestamp) from which the segment will be accessible for downloading.
3. Optional parameters, such as the duration of the segment or a number of repetitions, in order to optimize the description of the future segments.

This advance description allows the client terminal to schedule the downloading of future segments without waiting for their actual production, thereby improving the efficiency of the adaptive streaming system by reducing how often the manifest file is generated on the content server side and how often the manifest file is downloaded on the client terminal side (also referred to as the “HAS player”).

The remainder of this document focuses on describing an embodiment which, by way of example, is based on the MPEG-DASH standard. A person skilled in the art will have no difficulty in transposing the examples provided herein to other adaptive streaming techniques such as HLS or MSS, for example. Indeed, the invention described herein is not limited to the MPEG-DASH context but can be generalized to any adaptive streaming context in which content is described in the form of segments within a description file, or manifest, specifying various parameters for the segments.

One will recall that a manifest file is a description file used within the context of HTTP adaptive streaming (HAS). It contains detailed information about the audio and/or video segments of digital content, enabling the client terminal to locate, download, and render these segments.

The manifest file includes in particular:
1. The addresses of the segments, in the form of URLs or URL templates providing access to the segments.
2. The characteristics of the segments, such as their duration, quality (resolution, bit rate), and type (audio, video, subtitles, etc.).
3. The timeline of the segments, indicating the order and availability times of the segments.

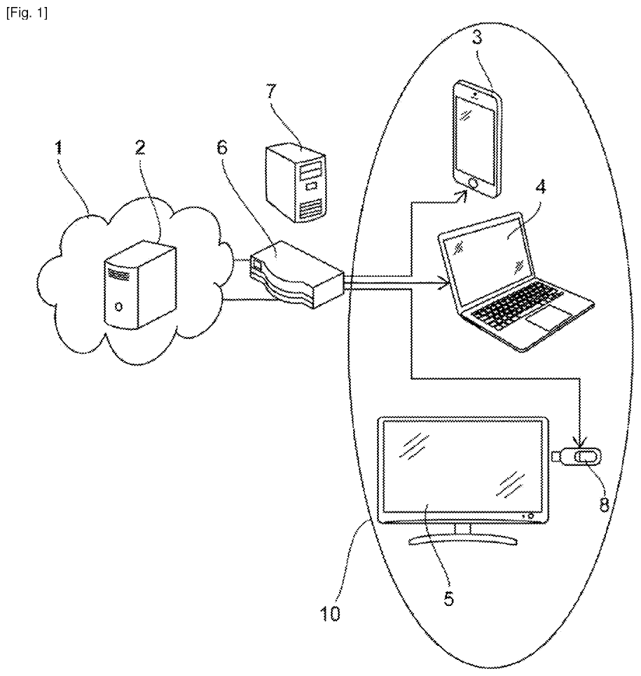

Reference is now made to FIG. 1, which illustrates an example of a streaming architecture based on the use of adaptive streaming in accordance with the invention.

Terminal 3, for example a smartphone, terminal 4, for example a laptop computer, and terminal 8, for example an HDMI stick connected to a television set 5, are located in this example within a Local Area Network (LAN, 10) managed by a residential gateway 6. This context of the local area network is provided solely as an example and could easily be transposed to a “best-effort” Internet network, an enterprise network, or a mobile radio communication network such as 3G, 3G+, 4G or 5G, etc.

In this example, a digital content server 2 is located in the Wide Area Network (WAN, 1). The content server 2 receives, for example, channels of digital television content originating from a broadcast television network (not shown), and/or other live audio and/or video content, and makes all this content available to the client terminals.

More generally, in the context of the invention, we are interested in the case of a multimedia streaming device wanting to access content on a content server 2 that is part of a communication network 1. The multimedia streaming device (for example, terminal 8) accesses the network 1 via an access point 6.

Furthermore, although FIG. 1 illustrates the case of a local area network 10 in which the access point 6 is a residential gateway, it will be understood that the invention also applies to cases where the access point 6 is a base station of a radio communication network such as 3G, 3G+, 4G, 5G, or 6G, which a mobile client terminal (for example, a smartphone 3) accesses in order to download live content from a content server 2 present on that network.

The client terminals 3, 4, and 8 can establish communication with the content server 2 in order to receive one or more content items (films, documentaries, ad sequences, etc.). Typically, a terminal sends a request to a server, indicating the chosen content, and in return it receives a stream of digital data corresponding to that content. Within the context of a local communication network, such a request passes through the network access gateway, for example a residential gateway. More generally, such a request passes through the access point 6 to the wide area network 1.

The terminal is adapted to receive this digital content in the form of multimedia data and to render it. This rendering process consists of presenting the digital content at the terminal in a user-accessible format. For example, received data corresponding to a video is typically decoded and then rendered at the terminal as a display of the corresponding video with its associated soundtrack.

In this client-server context, in order to exchange data between the client terminals 3, 4, and 8 and the server 2, it is common practice to employ an adaptive streaming technique that is based on the HTTP protocol and abbreviated as HAS. This type of technique allows offering high-quality content to the user by taking into account variations in bandwidth that may occur all along the connection between the client terminal 3, 4, or 8 and the content server 2.

Conventionally, different levels of quality may be encoded for the same channel content, for example corresponding to different bit rates. More generally, “quality” is used to refer to a specific resolution of the digital content (spatial resolution, temporal resolution, or a level of quality associated with video and/or audio compression) combined with a specific bit rate. Each level of quality is itself divided on the content server into temporal segments (or content “fragments” or “chunks”, these three terms being used interchangeably throughout this document).

The description of these various levels of quality and the associated temporal segmentation, as well as the content fragments themselves, are described for the client terminal and made available to it via their Internet addresses (URI: Universal Resource Identifier). All of these parameters (levels of quality, fragment addresses, etc.) are, in general, grouped together in a parameter file referred to as a description file. It should be noted that this parameter file may be a computer file or a set of descriptive information about the content, accessible at a specific address.

Terminals 3, 4, and 8 each possess their own specific characteristics in terms of decoding capabilities, display specifications, etc. In the context of adaptive streaming, these terminals can adapt their requests in order to receive and decode the content requested by the user at the quality that is their best match. The remainder of this description focuses specifically on the HDMI stick 8, which is for example an Orange® CléTV®.

In this example, the access point 6 is a residential gateway which handles the routing of data between the wide area network 1 and the local area network 10, and manages digital content in particular by ensuring its reception from the network. Decoding is performed by a multimedia stream player integrated into the HDMI stick 8. Alternatively, any other media streaming device present within the local area network 10 could be utilized, in particular a device such as an STB (Set-Top Box) or a gaming console (not shown) connected to a television set.

In this example, in order to view content, terminal 8 first queries the service gateway 6 to obtain the address of the description document 7 for the desired content, for example content C1. The service gateway 6 responds by providing the terminal with the address of the description file 7. Hereinafter, it will be assumed that this file is a manifest file compliant with the MPEG-DASH standard (denoted “C.mpd”), and that the terms “description file” or “manifest” will be used interchangeably depending on the context.

Alternatively, this file may be retrieved directly from an Internet server that is local or is external to the local area network.

A manifest file (MPD) compliant with the MPEG-DASH standard describes the digital content using XML (“eXtended Markup Language”) syntax, comprising a list of content in the form of segments conventionally described between an opening tag ((SegmentList)) and a closing tag ((/SegmentList)). This segmentation allows, in particular, fine-grained adaptation to bandwidth fluctuations. Each segment corresponds to a specific duration (the “duration” field), offers multiple levels of quality, and makes it possible to generate their addresses (URLs-Uniform Resource Locators).

According to the prior art, the <SegmentTimeline> section in <SegmentTemplate> describes the available segments that have already been produced by the content server. An example is provided below.

```
  <SegmentTemplate timescale=“30000”
media=“155_video_1_2_$Time$.mp4?m=1545421124”
initialization=“155_video_1_2_init.mp4?m=1545421124”
startNumber=“710”>
  <SegmentTimeline>
  <S t=“255197799” d=“360360” r=“8”/>
  <S t=“258441039” d=“334334”/>
  </SegmentTimeline>
</SegmentTemplate>
```

The “media” attribute within the <SegmentTemplate> properties defines the URL (download address) to which the client terminal directs its segment request. By default, this URL uses the variable syntax $Number$ to identify the specific segment requested, where Number corresponds to the segment identifier. When a client terminal requests the segment, it replaces this variable with the segment's numerical identifier. In the example illustrated above, the segments are identified by their timestamp data, and the variable $Time$ replaces the variable $Number$ in the URL of the “media” attribute. Thus, when a client terminal requests a segment, it replaces the variable with the segment's start time. This start time is specified in the properties of value t of the segment(S), in the <SegmentTimeline> object.

Indeed, the <SegmentTimeline> object serves to describe the timeline of video or audio segments in multimedia content. The values t, d and r in the <SegmentTimeline> object are respectively used to specify the start time, duration, and repetition of the segments, as described in greater detail below.

t (time) denotes the segment's start time in milliseconds. This indicates the specific moment where the segment begins in the overall timeline of the multimedia content. For example, t=“1000” means that the segment begins 1,000 milliseconds (1 second) after the start of the stream.

d (duration) denotes the segment's duration in milliseconds. This indicates how long the segment lasts. For example, d=“5000” signifies that the segment lasts for 5,000 milliseconds (5 seconds).

r (repeat) denotes the repetition of the segment. If this parameter is present, it indicates the number of times the segment is to be repeated after its initial duration. For example, r=“3” means that the segment will be repeated three times after its first occurrence, thereby increasing the total number of segments.

Once it has obtained the segment addresses corresponding to the desired content, the access point 6 proceeds to retrieve the segments by downloading them from these addresses. It should be noted that this download is performed conventionally here, via an HTTP URL, but could also be performed via a Universal Resource Identifier (URI) describing a different protocol (for example dvb://mycontentsegment).

The television set 5, via its connection to the HDMI stick 8 plugged into its HDMI port, is used to render a live television program, designated herein as content C1. Such content C1 is described in a manifest file 7.

In one example, a user wishes to view this multimedia content C1 on their television set 5, which is connected to an HDMI stick 8. The HDMI stick 8 is connected directly to the residential gateway 6 via Wi-Fi®. Alternatively, the HDMI stick 8 could be compliant with the IEEE 1905.1 standard and be connected to the residential gateway 6 via Power Line Communication technology.

The content segments obtained by the residential gateway 6 are, for example, transmitted via Wi-Fi® to the HDMI stick 8, which manages their display on the screen of the television set 5, presenting them to the user after they are decoded by a multimedia stream player integrated into the HDMI stick 8.

In one embodiment, it is proposed to introduce a new object into the manifest file, corresponding to a predictive section describing one or more future segments of the content C1 that have not yet been produced by the content server.

This new object, for example called <PredictiveSegmentTimeline>, may take the following form:

```
  <SegmentTemplate timescale=“30000”
media=“155_video_1_2_$Time$.mp4?m=1545421124”
initialization=“155_video_1_2_init.mp4?m=1545421124”
startNumber=“710”>
  <PredictiveSegmentTimeline>
  <S t=“255217799” d=“2000” r=“10”/>
  </ PredictiveSegmentTimeline >
  <SegmentTimeline>
  <S t=“255197799” d=“2000” r=“60”/>
  </SegmentTimeline>
</SegmentTemplate>
```

The above example of a <PredictiveSegmentTimeline> object describes the first future segment beginning at t=“255217799” and retrievable at the address media=“155_video_1_2_255217799.mp4?m=1545421124” once it has been produced by the content server, at the timestamp corresponding to its availability for download.

Similarly, <PredictiveSegmentTimeline> indicates that the second segment begins at time t+d=255217799+2000, that the third segment begins at t+2d, and so on for r=10 consecutive segments having the same duration d=2000 ms.

In an n example where not all segments are of the same duration, the <PredictiveSegmentTimeline> object could include multiple lines corresponding to groups of segments of identical duration.

For example:

```
  <SegmentTemplate timescale=“30000”
media=“155_video_1_2_$Time$.mp4?m=1545421124”
initialization=“155_video_1_2_init.mp4?m=1545421124”
startNumber=“710”>
  <PredictiveSegmentTimeline>
  <S t=“255197799” d=“360360” r=“8”/>
  <S t=“258441039” d=“334334”>
  </ PredictiveSegmentTimeline >
  <SegmentTimeline>
  <S t=“255197799” d=“2000” r=“60”/>
  </SegmentTimeline>
</SegmentTemplate>
```

Thus, the first segment begins at time t=“255197799” with a duration d=“360360”; there is a repetition of r=8 segments of the same duration d=“360360”; then, the next segment begins at t=“258441039” and has a duration d=“334334”.

The <PredictiveSegmentTimeline> section therefore describes segments that will be produced in the future and will be available starting at a specific timestamp.

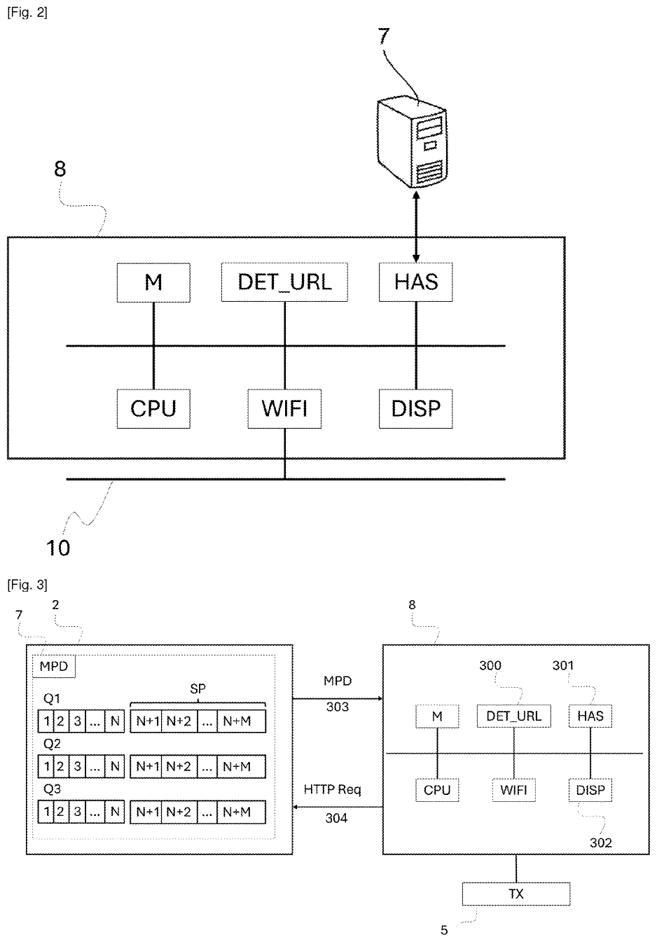

FIG. 2 represents an architecture of a multimedia streaming device according to such an embodiment of the invention, for example the HDMI stick 8 shown in FIG. 1, or a set-top box adapter unit, a gaming console, etc.

It conventionally comprises memory M associated with a processor CPU. These memories may be ROM (“Read-Only Memory”), or RAM (“Random-Access Memory”), or Flash memory. The HDMI stick 8 communicates with an access point to the wider Internet, for example the residential gateway 6, via a Wi-Fi module for local wireless communication.

Alternatively, communication between the HDMI stick 8 and the gateway 6 could be established using Power Line Communication technology compliant with the IEEE 1905.1 standard; in this case, the Wi-Fi module would be replaced by a PLC module in the architecture of FIG. 2.

In another alternative, the multimedia streaming device for which the architecture is presented in FIG. 2 could be a mobile phone, such as the smartphone in FIG. 1. In this case, the architecture in FIG. 2 could comprise a radio communication module RC allowing the terminal to communicate with a base station of a 4G or 5G network, either in parallel with or in place of the Wi-Fi module.

The HDMI stick 8 further comprises an adaptive streaming module (HAS) configured to request the streaming of specific content at one of the levels of quality proposed in a description file 7. This description file 7 may be stored in the memory M of the HDMI stick 8 for example, or it may be located externally. This description file 7 comprises in particular a predictive section relating to future segments of the content which have not yet been produced by the content server and therefore are not yet available for download by the terminal 8.

The HDMI stick 8 also comprises a URL construction module DET_URL which constructs download URL addresses for future segments of the content on the basis of data contained in the predictive section of the manifest file 7. This module DET_URL may generate URLs for all future segments (or alternatively for only a subset) covered in the predictive section, immediately upon receipt of the manifest file 7, without having to wait for these future segments to become available for download.

The URLs of future segments, constructed in this manner by this module DET_URL, may be temporarily stored in memory M while awaiting the specific moment at which these segments become available from the content server 2. When the current time corresponds to time t—the start time of a future segment described in the predictive section-module HAS retrieves the URL for that segment from memory M and requests the download of the segment from the retrieved URL.

The client terminal 8 also comprises a module DISP for controlling the display of content on the screen of a rendering terminal, for example the smartphone 3 or television 5. Such a module DISP serves as a module for managing the interface with the user's rendering terminal; through this module, the HDMI stick 8 can, for example, obtain information about any user interactions with the rendering terminal (actions performed on the TV remote control such as pressing a volume button or channel-change button, or selecting from a menu displayed on the TV screen a highlighted content to be downloaded). This module also allows controlling the display of pop-up windows on the screen of the rendering terminal, thereby allowing it to deliver messages, in particular information related to navigation in live content, for example if rewinding within the live stream.

According to one embodiment of the invention, the HDMI stick 8 may also contain other modules, such as a hard drive (not shown) for storing video fragments, a module for controlling access to content, and a module for processing commands received from a tablet or smartphone on which the application for controlling the HDMI stick is installed, by means of which the user can control its operation, etc. Indeed, such an HDMI stick 8 generally does not contain an interface module I/O, and it is the interface module I/O of the user's smartphone 3, tablet 4, or television 5 that is utilized by the user, for example to select content.

It should be noted that the term “module” may correspond to a software component, a hardware component, or a combination of hardware and software components. In turn, a software component corresponds to one or more computer programs or sub-programs, or more generally to any element of a program capable of implementing a specific function or set of functions as described for the modules concerned. Similarly, a hardware component corresponds to any element in a set of hardware capable of implementing a specific function or set of functions for the module concerned (integrated circuit, smart card, memory card, etc.).

More generally, such an HDMI stick 8 comprises volatile memory (for example RAM) and a processing unit equipped, for example, with a CPU and controlled by a computer program representing the adaptive streaming management module HAS and stored in non-volatile memory (for example ROM or a hard drive). Upon initialization, the code instructions of the computer program are, for example, loaded into the volatile memory before being executed by the processor CPU of the processing unit. The volatile memory in particular contains the manifest description file 7 and the URLs for future segments constructed by the module DET_URL based on information appearing in the predictive section of the manifest. The processor of the processing unit controls the determination of download addresses for future segments described in the predictive section of the manifest file, the display of pop-up windows on the screen of the rendering terminal, and the monitoring of timestamps of future segments in order to trigger their download as soon as they become available from the content server.

FIG. 2 illustrates only one among several possibilities for implementing a multimedia streaming device such that it can execute the steps of the method detailed below in conjunction with FIG. 3 (in any of the various embodiments or in a combination of these embodiments). Indeed, these steps may be implemented indiscriminately on a reprogrammable computing device (such as a PC, a DSP processor, or a microcontroller) executing a program comprising a sequence of instructions, or on a dedicated computing device (for example a set of logic gates such as an FPGA or an ASIC, or any other hardware module).

Presented below in relation to FIG. 3 is an example of managing adaptive streaming between a content server 2 and a client terminal 8, utilizing a predictive manifest file.

The multimedia streaming device 8 is connected to a rendering terminal TX (for example, the HDMI stick 8 is connected to the television 5 via an HDMI link). As described above in relation to FIG. 2, it comprises a module DISP 302 for interfacing with the rendering terminal TX, a module DET_URL 300 for determining the download addresses of future segments of live content, and a client module HAS 301.

A content server 2 provides live content C1 in the form of segments encoded at different qualities Q1, Q2, Q3.

According to the prior art, a client module HAS is responsible for retrieving these segments from the content server 2 by selecting the video quality Qi according to the available network resources. We do not describe in further detail here the manner in which the client module HAS selects the encoding bit rate for the next video fragment to be downloaded; indeed, numerous algorithms exist for making this selection, using strategies that range from relatively conservative to relatively aggressive. However, it should be noted that, in most cases, the general principle of such algorithms is based on downloading an initial fragment at the lowest encoding bit rate offered in the manifest, and evaluating the time required to retrieve this initial fragment. On this basis, the client module HAS assesses whether, depending on the size of the fragment and the time taken to retrieve it, the network conditions allow downloading the next fragment at a higher encoding bit rate. Some algorithms rely on gradually increasing the level of quality of the downloaded content fragments; others propose riskier approaches, with jumps between the encoding bit rate levels in the successive fragments.

In the conventional case, if a video “chunk” lasts 3 seconds, retrieval of that “chunk” by the client module HAS must not exceed 3 seconds, in order to enable uninterrupted rendering of the content by the terminal 8 in cases where the customer is watching live content. The client module HAS should therefore strike an optimal balance between rendering quality, and therefore the encoding bit rate, being as high as possible, and the fragment download time which must be sufficiently short to allow uninterrupted rendering on the rendering terminal TX.

During a step designated as 303, module HAS 301 retrieves the manifest file MPD 7 in order to discover what fragments of the video content C1 are available, as well as the various associated video qualities Qi.

In the embodiment illustrated in FIG. 3, during generation of the file MPD 7, the content server 2 also constructs a predictive section SP which describes future segments of the content C1, i.e. segments that have not yet been produced by the content server 2 but will be produced in the future. For example, segments with identifiers N+1 through N+M are future segments which are the subject of the predictive section SP.

Upon receipt of the file MPD 7 during step 303, the client module HAS 301 analyzes it to determine which segments have been made available by the content server—and at what quality level or encoding bit rate—as well as which future segments are predicted in the section SP, along with the future time at which they will be made available by the server 2.

The algorithm implemented by the client module HAS 301, to determine which fragment at which encoding bit rate should be downloaded during normal operation, may be any one of the existing algorithms known in the prior art. Therefore, this algorithm will not be described in further detail here.

During the analysis of the file MPD 7, the module DET_URL 300 analyzes the predictive section SP to construct the download addresses for future segments N+1 through N+M. For example, if the identifier for future segments N+1 through N+M is their timestamp, i.e. the specific time they become available for download, the module DET_URL 300 constructs the URL for future segments N+1 through N+M by successively replacing the $Time$ element, in the URL template media=“155_video_1_2_$Time$.mp4?m=1545421124” provided in the manifest file 7, with the value of the start time t for each of the future segments.

Where applicable, this time t is calculated as a function of the start time t of the first future segment (N+1), its duration d, and the number of repetitions r specified in the file MPD 7.

Once constructed, these URLs are for example stored in memory M while awaiting the time t associated with each of the future segments. A scheduler may be used to schedule the availability times for the various future segments and to program the issuing of download requests for these segments when the current time matches the time at which they become available from the content server 2.

Thus, when the current time corresponds to the start time t of one of the future segments, for example segment N+1, the terminal 8 sends an HTTP request 304 to download that segment N+1.

The various fragments downloaded by the client module HAS 301 are sent to the interface module DISP 302 for presentation to the user on the display screen of the rendering terminal TX.

The generation of the file MPD 7 by the content server 2 may be performed at a reduced frequency compared to prior art solutions, due to the presence of this predictive section SP. For example, the content server 2 regenerates the file MPD 7 only after having produced the entire set of future content segments N+1 to N+M described in the predictive section SP. The resources of the server 2 are thereby conserved.

The frequency of step 303 in which the client terminal 8 retrieves the manifest file MPD 7 is also reduced (for example, for segments with a duration of 2 seconds, if M=30, this frequency can be reduced by a factor of 30). This therefore also reduces bandwidth consumption between the client terminal 8 and the content server 2, as well as the resources utilized by the terminal 8 to read and analyze the file MPD 7.

### INDUSTRIAL APPLICATION

In its various embodiments, the invention can be implemented on adapter boxes or decoders (known as “set-top boxes”), on the Orange® CléTV®, on gaming consoles, and generally on all terminals that consume live content via HAS by means of an access point to a communication network, as well as on all servers of live content that break up audio/video streams into segments and provide a description of them in a manifest file.

The present disclosure is not limited to the examples of the method for managing HAS downloads, the content server, the method for HAS downloading of live content, and the multimedia streaming device described hereinabove which are provided solely by way of example, but instead encompasses all variants conceivable to a person skilled in the art within the scope of the protection sought.

1. A method for managing the adaptive streaming of live digital content from a content server to a multimedia streaming device, the method being implemented by a content server and comprising:
generating a description file for the digital content, the description file comprising a list of temporal segments of the content,
wherein generating comprises constructing a predictive section in the description file, the section describing, for at least one future segment of the digital content, a reserved identifier for that future segment and a temporal indication of a point in time from which the future segment will be available for download; and
transmitting the description file.

2. The method of claim 1, wherein the predictive section describes, for the at least one future segment:
a. a start time of the at least one future segment;
b. a duration of the at least one future segment.

3. The method of claim 2, wherein the temporal segments of the content are of equal duration, and wherein the predictive section also describes, for the at least one future segment, a number of repetitions of the at least one future segment.

4. The method of claim 1, wherein generating the description file is repeated only after the content server has produced the at least one future segment described in the predictive section.

5. A server for managing the adaptive streaming of live digital content, the server comprising:
at least one processor; and
at least one non-transitory computer readable medium comprising instructions stored thereon which when executed by the at least one processor configure the server to:
generate a description file for the digital content, the description file comprising a list of temporal segments of the content,
wherein generating comprises constructing a predictive section in the description file, the section describing, for at least one future segment of the digital content, a reserved identifier for that future segment and a temporal indication of a point in time from which the future segment will be available for download; and
transmit the description file.

6. (canceled)

7. A non-transitory computer-readable storage medium on which is stored a computer program which when executed by at least one processor of the content server configure the content server to implement the method according to claim 1.

8. A method for the adaptive streaming of live digital content from a content server by a multimedia streaming device, the method being implemented by the multimedia streaming device and comprising:
downloading a description file of the digital content, comprising a list of temporal segments of the content,
wherein the downloaded description file comprises a predictive section describing, for at least one future segment of the digital content, a reserved identifier for the future segment and a temporal indication of the moment from which said future segment will be available for download.

9. The method of claim 8, which further comprises:
a. constructing download addresses, based on the predictive section, for a plurality of future segments of the digital content;
b. downloading one of the future segments among the plurality, at the download address constructed for that future segment, starting at the moment associated with the temporal indication for the future segment.

10. The method of claim 9, wherein the download of the description file is repeated only upon completing the download of the plurality of future segments described in the predictive section.

11. A multimedia streaming device comprising:
at least one processor; and
at least one non-transitory computer readable medium comprising instructions stored thereon which when executed by the at least one processor configure the multimedia streaming device to adaptively stream live digital content from a content server, the adaptive streaming comprising:
downloading a description file of the digital content, comprising a list of temporal segments of the content,
wherein the downloaded description file comprises a predictive section describing, for at least one future segment of the digital content, a reserved identifier for the future segment and a temporal indication of the moment from which said future segment will be available for download.

12. (canceled)

13. A non-transitory computer-readable storage medium on which is stored a computer program which when executed by at least one processor of the multimedia streaming device configure the multimedia streaming device to implement the method according to claim 8.
